(19) United States
(12) Patent Application Publication
(10) Pub. No.: US 2016/0059454 A1
(43) Pub. Date: Mar. 3, 2016

(54) INJECTION MOLDING MACHINE AND INJECTION MOLDING METHOD UTILIZING THE SAME

(71) Applicants: BOE TECHNOLOGY GROUP CO., LTD., Beijing (CN); BOE OPTICAL SCIENCE AND TECHNOLOGY CO., LTD., Suzhou (CN)

(72) Inventors: Wenqi DONG, Beijing (CN); Hu LI, Beijing (CN); Mingfa CHEN, Beijing (CN)

(21) Appl. No.: 14/600,164

(22) Filed: Jan. 20, 2015

(30) Foreign Application Priority Data
Aug. 28, 2014 (CN) 201410431276.5

(51) Int. Cl. B29C 45/17; B29C 45/18

(52) U.S. Cl. CPC B29C 45/1701; B29C 45/18; B29C 2045/1875; B29L 2011/0075

(57) ABSTRACT

An injection molding machine, which comprises a hopper configured to feed materials and a non-reactive gas generating means connected with the hopper and configured to charge the hopper with non-reactive gas. The injection molding machine according to embodiments of the present invention completes the plasticization of the materials under protection of the non-reactive gas and avoids yellowing of a light guide plate (LGP) due to oxygenolysis of the materials.

### TECHNICAL FIELD

Embodiments of the present invention relate to an injection molding machine and an injection molding method utilizing the same.

### BACKGROUND

The lightweight and ultra-thin development trend of smart mobile phones and tablet PCs puts forward higher requirement on the thinning of display module devices. At present, a few high-end mobile devices adopt organic light-emitting diode (OLED) displays to achieve the ultra-thin tendency, but most manufacturers adopt liquid crystal displays (LCDs). As an LCD does not emit light itself and can only achieve clear image display by means of a backlight source, the overall size of a light guide plate (LGP), acting as a core component of the backlight source, plays a key role in the lightweight and thin tendency of the backlight source.

Currently, LGP is formed through injection molding by a high-speed molding machine. Generally, in the process of forming a sheet with a thickness less than 0.7 mm, in case of the same thickness, the larger the area of the LGP, the higher the requirement on the liquidity of materials; and in case of the same area of the LOP, the thinner the LGP, the higher requirement on the liquidity of materials. In the forming process, apart from selecting materials with high liquidity, the liquidity of the materials is improved by increasing temperature of a barrel of an injection molding machine. However, higher plastication temperature may result in thermal degradation and oxidization degradation of the materials, and hence the color of the formed LGP is yellowish. After the backlight comprising the LGP with yellowish color is lighted on, the color difference, measured by a BM-7 chrominance-luminance meter, is large. At present, more manufacturers select materials with high liquidity to solve the yellowing of the LGP. But the method not only increases the cost but also does not improve the effect obviously.

In view of this, an injection molding machine capable of avoiding the yellowing of an LGP in the manufacturing process and an injection molding method utilizing the injection molding machine are demanded.

### SUMMARY

At least one embodiment of the present invention provides an injection molding machine, which comprises a hopper configured to containing materials and a non-reactive gas generating device connected to the hopper and configured to charge the hopper with non-reactive gas.

According to one embodiment of the present invention, the injection molding machine further comprises a charging barrel and an injection cylinder communicated with the hopper in sequence; the charging barrel is provided with a screw for conveying the materials; the injection cylinder is provided with an injection plunger; a nozzle is formed on the injection cylinder; and the injection plunger is configured to extrude the materials from the nozzle.

According to one embodiment of the present invention, the screw is driven by a motor and the injection plunger is driven by a driver.

According to one embodiment of the present invention, the non-reactive gas generating means comprises a nitrogen generator; and one end of the nitrogen generator is connected to the hopper and the other end is connected with the driver.

According to one embodiment of the present invention, the non-reactive gas generating means comprises a nitrogen generator, a detection probe and a signal controller; the detection probe is disposed in the hopper and electrically connected with the signal controller; and the signal controller is configured to control ON/OFF of the nitrogen generator.

According to one embodiment of the present invention, the injection molding machine further comprises an air compressor connected with the nitrogen generator.

At least one embodiment of the present invention further provides an injection molding method, which comprises:

S1: the non-reactive gas generating means replacing oxygen in the hopper with non-reactive gas.

Wherein, after the step S1, the injection molding method further comprises following steps:

S2: the screw rotates and materials being fed into the charging barrel after the oxygen in the hopper is replaced by the non-reactive gas; and

S3: the driver driving the injection plunger to extrude the materials from the nozzle, and LGP being formed.

According to one embodiment of the present invention, the step S1 comprises:

S11: the driver switches the nitrogen generator of the non-reactive gas generating means on.

According to one embodiment of the present invention, the step S1 comprises:

S11′: the detection probe of the non-reactive gas generating means detecting the oxygen content in the hopper and transmitting a signal to the signal controller; and

S12′: the signal controller determining whether the oxygen content exceeds a preset value or not, switching the nitrogen generator of the non-reactive gas generating means ON when the oxygen content exceeds the default value, and switching the nitrogen generator of the non-reactive gas generating means OFF when the oxygen content does not exceed the preset value.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic structural view of an injection molding machine according to embodiment 1 of the present invention;

FIG. 2 is a schematic structural view of an injection molding machine according to embodiment 2 of the present invention;

FIG. 3 is a control flow chart of the injection molding machine according to embodiment 2 of the present invention; and

FIG. 4 is a flow chart of an injection molding method according to one embodiment of the present invention.

### DETAILED DESCRIPTION

In the description of the present invention, unless otherwise specified, the term “a plurality of” indicates two or more than two. The orientation or position relationship indicated by the terms “above”, “below”, “left”, “right”, “inside”, “outside”, etc. is the orientation or position relationship as illustrated by the accompanying drawings. The terms are only conducive to the description of the embodiments of the present invention and the brief description and not intended to indicate or hint that an indicated component or element must have specified orientation and be constructed or operated in specified orientation, and hence should not be construed as a limitation of the present invention.

In the description of the present invention, it should be noted that: unless otherwise specified, the terms “mounted”, “connected” and “connection” should adopt broad understanding, for instance, may be fixed connection and may also be detachable connection or integrated connection, may be mechanical connection and may also be electrical connection, and may be direct connection and may also be indirect connection via an intermediate. The meaning of the terms in the present invention can be understood by those skilled in the art according to actual conditions.

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

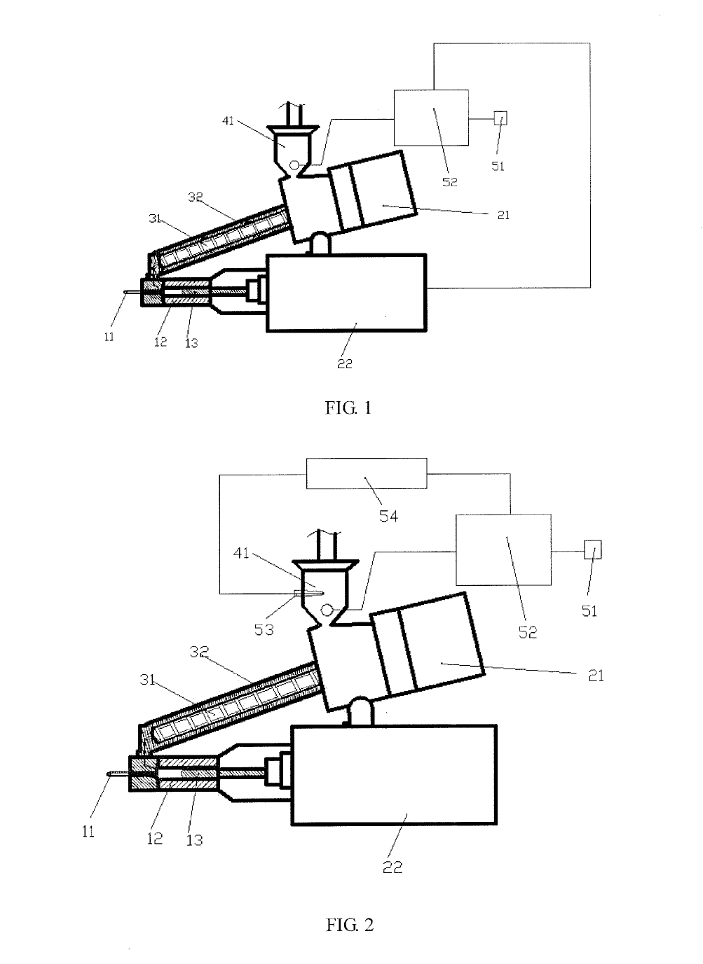

As illustrated in FIGS. 1 and 2, the injection molding machine according to one embodiment of the present invention comprises a hopper 41 configured to feed materials and a non-reactive gas generating means connected with the hopper 41 and configured to charge the hopper 41 with non-reactive gas.

The injection molding machine according to one embodiment of the present invention further comprises a charging barrel 32 and an injection cylinder 12 communicated with the hopper 41 in sequence; the charging barrel 32 is provided with a screw 31 for conveying and plasticizing material; the injection cylinder 12 is provided with an injection plunger 13; a nozzle 11 is formed on the injection cylinder 12; and a driver drives the injection plunger 13 to extrude materials from the nozzle 11. The screw 31 is driven by a motor 21; the injection cylinder 12 is driven by the driver in an injection control system 22; and the driver can be a motor and can also be a hydraulic press or an air compressor.

In the embodiment, the hopper 41 is disposed on the top of the motor 21 which drives the screw 31 to rotate; the hopper 41 is disposed on the top of the charging barrel 32 which is communicated with a front end of the injection cylinder 12; the nozzle 11 is formed at a front end of the injection cylinder 12 and communicated with the injection cylinder 12; the injection plunger 13 is connected with the injection control system 22; the injection control system 22 is provided with a driver which is a motor, an air compressor or a hydraulic press; and the driver drives the injection plunger 13 to extrude the materials from the nozzle 11. By providing the hopper 41 with a non-reactive gas generating means, air in the materials can be replaced by high-purity non-reactive gas, so that oxidization or hydrolysis between oxygen or water vapor in the air and high-temperature materials in the hopper 41 can be avoided, and hence yellowing of a formed LGP can be avoided and optical properties of the LGP can be guaranteed.

By adopting the non-reactive gas in the LGP injection molding machine so as to assist the plasticizing process, the injection molding of the LGP is completed under protection of the non-reactive gas, and hence the yellowing of the LGP can be effectively solved. In the embodiment, the non-reactive gas generating means is a nitrogen generator 52 configured to charging the hopper 41 with nitrogen. The nitrogen generator 52 separate oxygen and nitrogen by utilizing solid adsorbent with high performance and high selectivity for the selective adsorption of nitrogen and oxygen. In the embodiment, the nitrogen is provided by the nitrogen generator 52, so that the injection molding machine has advantages of reduced manufacturing cost, easy implementation and high reliability. In addition, commercially available bottled nitrogen or equipments for producing nitrogen by adoption of other operating principles can also be adopted. Compared with the technical proposal in which materials with higher liquidity are adopted to solve the yellowing of the LGP, the method according to the embodiment of the present invention not only is easy to implement and has better effect but also will not greatly increase the manufacturing cost of the LGP.

### Embodiment 1

As illustrated in FIG. 1, the non-reactive gas generating means according to embodiment 1 of the present disclosure comprises a nitrogen generator 52; and one end of the nitrogen generator 52 is connected with the hopper 41 and the other end is connected with the driver. The driver controls the nitrogen generator 52 to be switched on and to generate nitrogen. The nitrogen generator 52 is connected with an air compressor 51. Air is collected by the air compressor 51 and produced compressed gas is conveyed into the nitrogen generator 52 through a pipeline.

As illustrated in FIG. 4, the method for injection molding of a non-yellowing LGP by means of the injection molding machine according to the embodiment comprises the following steps:

S1: charging the hopper 41 with nitrogen generated by the nitrogen generator 52;

S2: the screw 31 rotating and feeding materials into the charging barrel 32 after oxygen in the hopper 41 being replaced by nitrogen;

S3: the driver driving the injection plunger 13 to extrude the materials from the nozzle 11, for instance, by means of injection molding. The injection molding method is a process for manufacturing a component made of thermoplastic plastics or thermosetting plastics. In the embodiment, plastic particles (in the embodiment, made of polymethyl methacrylate or a polycarbonate) arc heated to melt in the charging barrel of the injection molding machine; when molten plastics are in a flow state, the molten plastic is compressed and driven to move forward under the pressurization of the plunger or the screw and hence injected into a low-temperature closed mold at a high speed through the nozzle at the front end of the charging barrel; and after cooling and shaping for a certain period, the LGP can be obtained when the mold is opened.

Wherein, the step S1 comprises: S11: the driver switching the nitrogen generator 52, acting as the non-reactive gas generating means, ON. In operation of the injection molding machine according to the embodiment, the nitrogen generator 52 is driven by the driver in the injection control system 22; and in feeding material, the driver outputs a signal to control the nitrogen generator 52 to be switched on. The nitrogen generator 52 charge the hopper with nitrogen, and at the same time, the screw 31 rotates and feeds materials into the charging barrel 32, and hence the plasticization of the plastic particles can be completed.

### Embodiment 2

A structure of an injection molding machine according to the embodiment 2 is substantially the same as the structure of embodiment 1. No further description will be given to the similarity. The difference exists in the non-reactive gas generating means.

As illustrated in FIG. 2, in the injection molding machine according to the embodiment 2, the non-reactive gas generating means comprises a nitrogen generator 52, a detection probe 53 and a signal controller 54; the detection probe 53 is disposed in the hopper 41 and electrically connected with the signal controller 54; and the signal controller 54 is configured to control ON/OFF of the non-reactive gas generating means. The detection probe 53 is configured to detect oxygen in the hopper 41, supply different signals according to the oxygen content, and transmit the signal to the signal controller 54. The signal controller 54 is configured to analyze the received signal. When the oxygen content exceeds a preset value, the signal controller output a signal for inducing the nitrogen generator 52 to operate; generated nitrogen is charged into the hopper 41; and at this point, the oxygen content is reduced; and a signal detected by the detection probe 53 is finally transmitted to the nitrogen generator 52 and the nitrogen generator 52 ceases operating.

The detection probe 53 in the embodiment is an electrochemical sensor which can convert the oxygen content in the gas into an electrical signal which reflects the oxygen concentration. The detection range in 0 to 10,000 ppm, with a resolution of 1 ppm (generally, the oxygen content in the air being 20.95%=209,500 ppm).

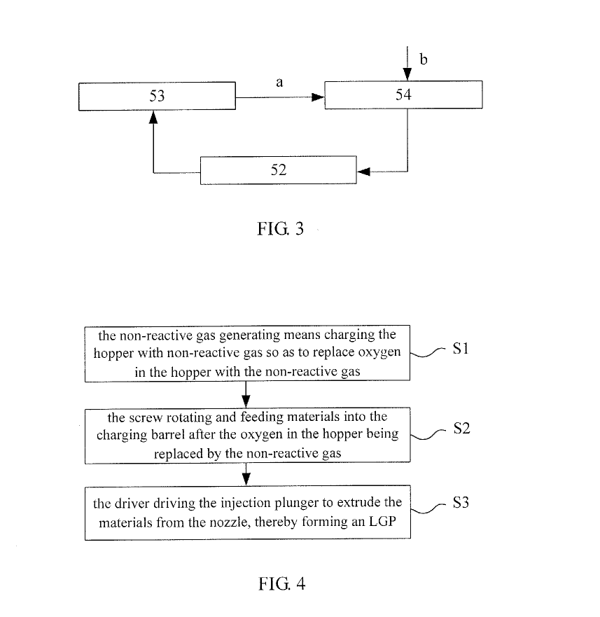

As illustrated in FIG. 3, the signal controller 54 performs comparison operation on the electrical signal transmitted by the detection probe 53 and the preset value, and outputs a signal a according to the operation result to control ON/OFF of the nitrogen generator 52. After an electrical signal value a detected by the detection probe 53 is compared with a preset value b set by the signal controller 54, the signal controller 54 outputs a signal to switch the nitrogen generator 52 ON or OFF. As the LGP is subjected to high-temperature plasticization under the protection of nitrogen, the oxidation reaction between oxygen and materials in the plasticizing charging barrel can be avoided, and hence the non-yellowing LGP can be manufactured.

In the operation of the injection molding machine according to the embodiment, the signal controller 54 controls the nitrogen generator 52 to be ON or OFF. The signal controller 54 is connected with the detection probe 53. By providing the detection probe 53, the replacement of nitrogen with oxygen in the hopper 41 can be controlled more accurately, so that nitrogen resources can be saved, and hence the cost can be saved. Moreover, the service life of the nitrogen generator 52 can be prolonged, and whether the nitrogen generator 52 operates normally can also be detected. After the detection probe 53 detects the oxygen content in the hopper 41, the detection probe 53 outputs a signal to the signal controller 54 which determines whether the oxygen content exceeds the preset value. If the oxygen content exceeds the preset value, the nitrogen generator 52 is controlled to be switched ON; when the material in the hopper 41 enters the charging barrel 32, the surrounding gas compositions are changed, the absolute oxygen content is decreased, and the nitrogen content is increased. As the chemical stability of the nitrogen is higher than that of the oxygen, the nitrogen has protective function on material plasticization, and hence the oxygenolysis of the LGP due to the oxygen can be avoided. If the oxygen content does not exceed the preset value, the signal controller 54 controls the nitrogen generator 52 to be switched OFF.

The method for injection molding of the non-yellowing LGP by means of the injection molding machine according to embodiment 2 is the same as that of embodiment 1. No further description will be given here. Wherein, the step S1 comprises:

S11′: the detection probe 53 of the non-reactive gas generating means outputting a signal to the signal controller 54 after detecting oxygen content in the hopper 41; and

S12′: the signal controller 54 determining whether the oxygen content exceeds a preset value, controlling the nitrogen generator 52 of the non-reactive gas generating means to be switched ON if the oxygen content exceeds the preset value, and controlling the nitrogen generator 52 of the non-reactive gas generating means to be switched OFF if the oxygen content does not exceed the preset value.

The LGP manufactured according to the embodiment of the present disclosure can be applied in a backlight module. The backlight module can be applied in a display device, which can be any product or component with display function such as an LCD panel, e-paper, an OLED panel, an LCD TV, an LCD, a digital picture frame, a mobile phone, a tablet PC and etc.

In summary, the injection molding machine according to the embodiment of the present invention has the following advantages: as the injection molding machine according to the present invention is provided with a hopper configured to feed the materials and a non-reactive gas generating means connected with the hopper and configured to charge the hopper with non-reactive gas, the injection molding machine according to the present disclosure completes the plasticization of the material under the protection of the nitrogen. The injection molding machine effectively solves the yellowing of the LGP due to the oxygenolysis of the material, and has the characteristics of low cost, easy implementation and high reliability.

Moreover, the detection probe cooperates with the signal controller. By providing the detection probe, replacement of the oxygen in the hopper with the non-reactive gas can be controlled more accurately, and hence the non-reactive gas resources can be saved, and consequently the cost can be saved. In addition, the service life of the non-reactive gas can be prolonged, and whether the non-reactive gas generating means operates normally can also be detected.

The foregoing are merely exemplary embodiments of the invention, but are not used to limit the protection scope of the invention. The protection scope of the invention shall be defined by the attached claims.

The present disclosure claims priority of Chinese Patent Application No. 201410431276.5 filed on Aug. 28, 2014, the disclosure of which is hereby entirely incorporated by reference.

1. An injection molding machine, comprising a hopper configured to feed materials and a non-reactive gas generating means connected with the hopper and configured to introduce non-reactive gas into the hopper.

2. The injection molding machine according to claim 1, further comprising a charging barrel and an injection cylinder communicated with the hopper in sequence, the charging barrel provided with a screw for conveying the materials, the injection cylinder provided with an injection plunger, a nozzle formed on the injection cylinder, the injection plunger configured to extrude the materials from the nozzle.

3. The injection molding machine according to claim 2, wherein the screw is driven by a motor and the injection plunger is driven by a driver.

4. The injection molding machine according to claim 3, wherein the non-reactive gas generating means comprises a nitrogen generator; and one end of the nitrogen generator is connected with the hopper and the other end is connected with the driver.

5. The injection molding machine according to claim 3, wherein the non-reactive gas generating means comprises a nitrogen generator, a detection probe and a signal controller;
the detection probe is disposed in the hopper and electrically connected with the signal controller; and the signal controller is configured to control ON/OFF of the nitrogen generator.

6. The injection molding machine according to claim 4, further comprising an air compressor connected with the nitrogen generator.

7. The injection molding machine according to claim 5, further comprising an air compressor connected with the nitrogen generator.

8. An injection molding method employing the injection molding machine according to claim 1, comprising:
S1: the non-reactive gas generating means charging the hopper with non-reactive gas so as to replace oxygen in the hopper with the non-reactive gas.

9. The injection molding method according to claim 8, further comprising followings after S1:
S2: the screw rotating and feeding materials into the charging barrel after the oxygen in the hopper being replaced by the non-reactive gas; and
S3: the driver driving the injection plunger to extrude the materials from the nozzle, thereby forming a light guide plate.

10. The injection molding method according to claim 9, wherein S1 comprises:
S11: a driver controlling the nitrogen generator of the non-reactive gas generating means to be switched ON.

11. The injection molding method according to claim 9, wherein S1 comprises:
S11′: a detection probe of the non-reactive gas outputting a signal to the signal controller after detecting the oxygen content in the hopper; and
S12′: the signal controller determining whether the oxygen content exceeds a preset value, and controlling ON/OFF of the nitrogen generator of the non-reactive gas generating means according to whether the oxygen content exceeds the preset value or not.
